(19) United States
(12) Patent Application Publication
(10) Pub. No.: US 2025/0203545 A1
(43) Pub. Date: Jun. 19, 2025

(54) NETWORK ENERGY SAVING TECHNIQUES FOR RRC CONNECTED

(71) Applicant: Lenovo (Singapore) Pte. Ltd., Singapore (SG)

(72) Inventors: Prateek Basu Mallick, Dreieich (DE); Hyejung Jung, Northbrook, IL (US); Ahmed Hindy, Aurora, IL (US); Joachim Löhr, Wiesbaden (DE); Tapisha Soni, Munich (DE); Vijay Nangia, Woodridge, IL (US)

(21) Appl. No.: 18/980,553

(22) Filed: Dec. 13, 2024

Related U.S. Application Data
(60) Provisional application No. 63/610,881, filed on Dec. 15, 2023.

(51) Int. Cl. H04W 56/00; H04W 24/10; H04W 76/20; H04W 80/02

(52) U.S. Cl. CPC H04W 56/0015; H04W 24/10; H04W 76/20; H04W 80/02

(57) ABSTRACT

Various aspects of the present disclosure relate to transmitting a configuration for a serving cell associated with an irregular synchronization signal block (SSB) transmission pattern. Aspects of the present disclosure may relate to transmitting an indication for activation of SSB transmissions for the serving cell. Aspects of the present disclosure may relate to broadcasting at least one SSB transmission in the serving cell in accordance with the configuration.

### TECHNICAL FIELD

The present disclosure relates to wireless communications, and more specifically to network energy saving techniques for a UE in the Radio Resource Control (RRC) connected state.

### BACKGROUND

A wireless communications system may include one or multiple network communication devices, which may be known as a network equipment (NE) supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A base station for wireless communication is described. The base station may be configured to, capable of, or operable to transmit a configuration for a serving cell associated with an irregular synchronization signal block (SSB) transmission pattern; transmit an indication for activation of SSB transmissions for the serving cell; and broadcast at least one SSB transmission in the serving cell in accordance with the configuration.

A processor for wireless communication is described. The processor may be configured to, capable of, or operable to transmit a configuration for a serving cell associated with an irregular synchronization signal block (SSB) transmission pattern; transmit an indication for activation of SSB transmissions for the serving cell; and broadcast at least one SSB transmission in the serving cell in accordance with the configuration.

A method performed or performable by a base station for wireless communication is described. The method may include transmitting a configuration for a serving cell associated with an irregular synchronization signal block (SSB) transmission pattern; transmitting an indication for activation of SSB transmissions for the serving cell; and broadcasting at least one SSB transmission in the serving cell in accordance with the configuration.

A UE for wireless communication is described. The UE may be configured to, capable of, or operable to receive, from a serving radio access network (RAN), a configuration for a first cell associated with an irregular SSB transmission pattern; receive an indication for activation of SSB transmissions for the first cell; perform one or more measurements based on an SSB transmission associated with the first cell and in accordance with the configuration.

A processor for wireless communication is described. The processor may be configured to, capable of, or operable to receive, from a serving radio access network (RAN), a configuration for a first cell associated with an irregular SSB transmission pattern; receive an indication for activation of SSB transmissions for the first cell; perform one or more measurements based on an SSB transmission associated with the first cell and in accordance with the configuration.

A method performed or performable by a UE for wireless communication is described. The method may include receiving, from a serving radio access network (RAN), a configuration for a first cell associated with an irregular SSB transmission pattern; receiving an indication for activation of SSB transmissions for the first cell; performing one or more measurements based on an SSB transmission associated with the first cell and in accordance with the configuration.

### BRIEF DESCRIPTION OF THE DRAWINGS

FIG. 1 illustrates an example of a wireless communications system in accordance with aspects of the present disclosure.

FIG. 2 illustrates an example of a protocol stack, in accordance with aspects of the present disclosure.

FIG. 3 illustrates an example of a measurement procedure involving a cell having an irregular SSB transmission pattern, in accordance with aspects of the present disclosure.

FIG. 4 illustrates an example of an SSB discontinuous transmission (DTX) pattern, in accordance with aspects of the present disclosure.

FIG. 5 illustrates an example of a UE, in accordance with aspects of the present disclosure.

FIG. 6 illustrates an example of a processor, in accordance with aspects of the present disclosure.

FIG. 7 illustrates an example of a NE, in accordance with aspects of the present disclosure.

FIG. 8 illustrates a flowchart of a method performed by a NE entity, in accordance with aspects of the present disclosure.

FIG. 9 illustrates a flowchart of a method performed by a UE, in accordance with aspects of the present disclosure.

### DETAILED DESCRIPTION

Generally, the present disclosure describes systems, methods, and apparatuses for cell measurement of network energy saving cells. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

Emissions and energy consumption from different elements of a telecommunication system are adversely contributing to the climate. Synchronization signal and physical broadcast channel (SS/PBCH) transmissions are necessary for initial access of a radio access network, yet cause significant network energy consumption. Moreover, these SS/PBCH transmissions are wasted energy when no UE is attempting to access the cell.

Additionally, the operating expenses to run a telecommunication services are huge. In telecommunications, a number of industry-specific factors rooted in countering rising network costs have further shaped efficiency efforts. A continued rise in mobile data traffic, estimated at 6.4 gigabytes (GB) per user per month in 2019 and forecast to grow threefold on a per-user basis over the next five years. Combined with the rising costs of spectrum, capital investment and ongoing RAN maintenance/upgrades, energy-saving measures in network operations are necessary rather than nice to have.

5G New Radio (NR) offers a significant energy-efficiency improvement per gigabyte over previous generations of mobility. However, new 5G use cases and the adoption of mm Wave will require more sites and antennas. This leads to the prospect of a more efficient network that could paradoxically result in higher emissions without active intervention.

A study on network energy saving in NR justifies the need for energy saving. Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g., extended reality (XR) services and applications), networks are being denser, use more antennas, larger bandwidths, and more frequency bands. The environmental impact of 5G needs to stay under control, and novel solutions to improve network energy savings need to be developed.

Energy consumption has become a key part of the operators' operating expenses. By some reports, the energy cost on mobile networks accounts for approximately 23% of the total operator cost. Most of the energy consumption comes from the radio access network and in particular from the Active Antenna Unit (AAU), with data centers and fiber transport accounting for a smaller share. The power consumption of a radio access can be split into two parts: the dynamic part which is only consumed when data transmission/reception is ongoing, and the static part which is consumed all the time to maintain the necessary operation of the radio access devices, even when the data transmission/reception is not on-going.

Although a UE power consumption model was already defined by the 3rd Generation Partnership Project (3GPP), there was a need to study and develop a network energy consumption model especially for the base station, key performance indicators (KPIs), an evaluation methodology and to identify and study network energy savings techniques in targeted deployment scenarios. The study investigated how to achieve more efficient operation dynamically and/or semi-statically and finer granularity adaptation of transmissions and/or receptions in one or more of network energy saving techniques in time, frequency, spatial, and power domains, with potential support/feedback from UE, potential UE assistance information, and information exchange/coordination over network interfaces.

The 3GPP study not only evaluated the potential network energy consumption gains, but also assessed and balanced the impact on network and user performance, e.g., by looking at KPIs such as spectral efficiency, capacity, user perceived throughput (UPT), latency, UE power consumption, complexity, handover performance, call drop rate, initial access performance, service level agreement (SLA) assurance related KPIs, etc.

A network expends substantial energy in transmitting Synchronization Signal Block (SSBs), Physical Broadcast Channel (PBCH) (i.e., containing the Master information block (MIB) and System information block #1 (SIB1). In the legacy 5G network, the System information blocks (SIBs) apart from SIB1 can already be provided on demand.

To solve the problems with network energy consumption discussed herein, the present disclosure describes how energy can be saved with respect to SSBs and SIB1. One straightforward option is to provide these as well on an as-need basis, i.e., transmitted on an on-demand basis. Another other option is to not provide SSBs and SIB1 in energy-saving cells, and instead use an anchor cell as a proxy transmitter (e.g., for time-frequency synchronization, SIB1) for these energy-saving cells.

Because a network serves RRC Idle/Inactive UEs as well as RRC Connected UEs, and the service requirements and UE activity in these RRC states are very different from each other, the energy saving techniques for the network should also deal with these separately.

To further solve the problems with network energy consumption discussed herein, the present disclosure discloses UE and network methods enabling network energy saving for RRC Connected UEs.

In various embodiments, the aspects of the present disclosure optimize the energy savings in the network by allowing an energy-saving cell to transmit SSB only when the same SSB is actually being measured by a RRC Connected UE. In a first aspect of the disclosure, the network (e.g., the master node (MN) or a secondary node (SN)) explicitly indicates to the UE that a particular cell (e.g., a secondary cell (SCell)) is not transmitting SSBs regularly (i.e., has an irregular SSB transmission pattern). Additionally, the UE prioritizes measurement of such cell/object, such that the UE starts with the measurement of the particular cell before any other measurements. In certain implementations, the network may use the parameter measSequence to achieve this purpose, wherein the UE prioritizes measurement of such a measurement object.

In a second aspect of the present disclosure, the UE signals a start time to measure a measurement object. Accordingly, the SSB may be provided on-demand. In certain implementations, the start time may be included in an Assistance Information and can be expressed as an offset. In certain implementations, the UE may also include a periodicity value e.g., in milliseconds telling the serving network how often it would keep measuring the target object to ensure that the measurements remain fresh and useful and thereby correct mobility decisions are made.

In a third aspect of the present disclosure, the UE assumes the SSB transmissions are present starting from a first SS/PBCH block Measurement Timing Configuration (SMTC) occasion following reception of the assistance information from the network (including processing times) and that satisfy the SMTC occasion system frame number (SFN) and subframe condition according to the periodicity and offset parameters for the SMTC. In certain implementations, the UE may indicate (e.g., in Assistance information signaling) to the network a preferred minimum number of measurement windows/SMTC occasions in which to receive SS/PBCH blocks. In certain embodiments, Assistance information from the network may indicate the number of SMTC occasions (including until cancelled (e.g., by another signaling from the network)) starting from the first SMTC occasion the UE can assume the presence of SSB transmissions. Assistance information may also include one or more of SMTC parameters e.g., periodicity, offset, duration, SSB to measure, etc.

Based on this knowledge of expected UE measurements, the network switches on the SSBs and will switch this back off at a point synchronized with the UE, obliging the UE to finish measurements before the SSB transmissions are again turned off. Note that the techniques described herein for requesting SSB may also be used by a UE to request channel state information reference signal (CSI-RS) resources (e.g., for mobility).

In a fourth aspect of the present disclosure, the UE must finish the measurement within a time period. The time period e.g., 100 ms can be specified, or can be configured by the network along with the measurement configuration provided to the UE or can be broadcasted. Alternatively, the UE uses Assistance information to inform the network when the measurement of the measurement object (no-SSB-cell-frequency) is complete. As another possibility, the reception of measurement report containing measurement result of the measurement object tells the network that the SSB of the cell (SCell) can be switched off.

In a fifth aspect of the present disclosure, a cell SSB-DTX pattern is revealed, which is a pattern of time periods when SSB is transmitted (active time) and time periods when SSB is not transmitted (not-active or SSB-sleep time). Using this pattern, the network informs the UEs when SSB will and will not be transmitted by otherwise non-SSB transmitting cell, e.g., associated with a certain measurement object. In some embodiments, the SSB-DTX pattern is configured (and released) using RRC signaling and activated and deactivated by Layer-1 (L1) signaling. In certain embodiments, the L1 signaling may be UE-specific signaling, i.e., addressing UE specific cell radio network temporary identifier (C-RNTI). Alternatively, the L1 signaling may be group common signaling, e.g., using a reserved radio network temporary identifier (RNTI) or an RNTI configured to a plurality of RRC Connected UEs. One or more UEs attempt measurement of the measurement object (i.e., associated with the otherwise non-SSB transmitting cell) only during the active time of the SSB-DTX pattern, i.e., when the cell is in SSB transmission (active) state.

In a sixth aspect of the present disclosure, to save energy in the network, a new concept of SSB-activation and SSB-deactivation can be used. Interactions with the new SSB-activation/SSB-deactivation and the SCell Activation/SCell Deactivation are disclosed herein. In certain implementations, a serving cell configuration for a UE includes a configuration for semi-persistent SSB, indicating that the serving cell transmits SSB semi-persistently based on an activation/deactivation command.

In a seventh aspect of the present disclosure, procedures are disclosed for on-demand provisioning System Information of a SCell using new/enhanced RRC Dedicated SIB Request containing a cell identification and SIB number.

In an eighth aspect of the present disclosure, the measurement configuration includes information of a set of associated cells, where a measurement report for a first cell of the set of associated cells implicitly indicates a request for SSB transmission in a second cell of the set of associated cells.

Aspects of the present disclosure are described in the context of a wireless communications system.

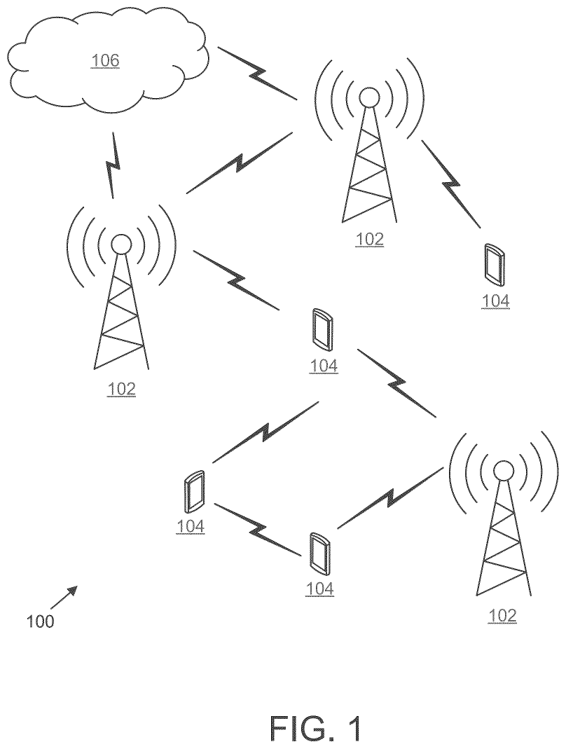

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHZ), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Wireless communication in unlicensed spectrum (also referred to as “shared spectrum”) in contrast to licensed spectrum offer some obvious cost advantages allowing communication to obviate overlaying operator's licensed spectrum and rather use license free spectrum according to local regulation in specific geographies. From the Third Generation Partnership Project (3GPP) technology perspective, the unlicensed operation can be on the Uu interface (referred to as NR-U) or also on sidelink interface (e.g., SL-U).

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

After performing DL synchronization and acquiring essential system information, such as the Master Information Block (MIB) and the System Information Block type 1 (SIB1), the UE 104 performs uplink (UL) synchronization and resource request by performing a random access procedure, referred to as “RACH procedure” by selecting and transmitting a preamble on the Physical Random Access Channel (PRACH). The PRACH preamble is transmitted during a RACH occasion, i.e., a predetermined set of time-frequency resources that are available for the reception of the PRACH preamble. Note that with beam-based communication, the UE 104 may select a certain DL beam and transmit the PRACH preamble on a corresponding UL beam. In such embodiments, there may be a mapping between SSB and RACH occasion, allowing the network to determine which beam the UE 104 has selected.

To complete the RACH procedure, after transmitting the PRACH preamble (also referred to as “Msg1”), the UE 104 monitors for a random-access response (RAR) message (also referred to as “Msg2”). The gNB transmits UL timing adjustment information in the RAR and may also schedule an UL resource, referred to as an initial uplink grant.

In 3GPP New Radio (NR), the gNB may transmit the maximum 64 SSBs and the maximum 64 corresponding copies of Physical Downlink Control Channel (PDCCH) and/or Physical Downlink Shared Channel (PDSCH) for delivery of SIB1 in high frequency bands (e.g., 28 GHz). This may cause significant network energy consumption even for a very low traffic load condition. According to 3GPP Technical Report (TR) 38.864 (v18.1.0), for network energy savings, on-demand SSB and/or SIB1 (SSB/SIB1) transmissions and a cell without SSB/SIB1 transmission were considered. When a cell does not transmit SSB/SIB1, for a UE to access the cell, the UE should obtain S1 of the cell from other associated carriers/cells and synchronize from other associated carriers/cells. When a cell is in a long period of cell inactivity, a UE served by the cell can trigger SSB/SIB1 transmissions by sending a request to the cell.

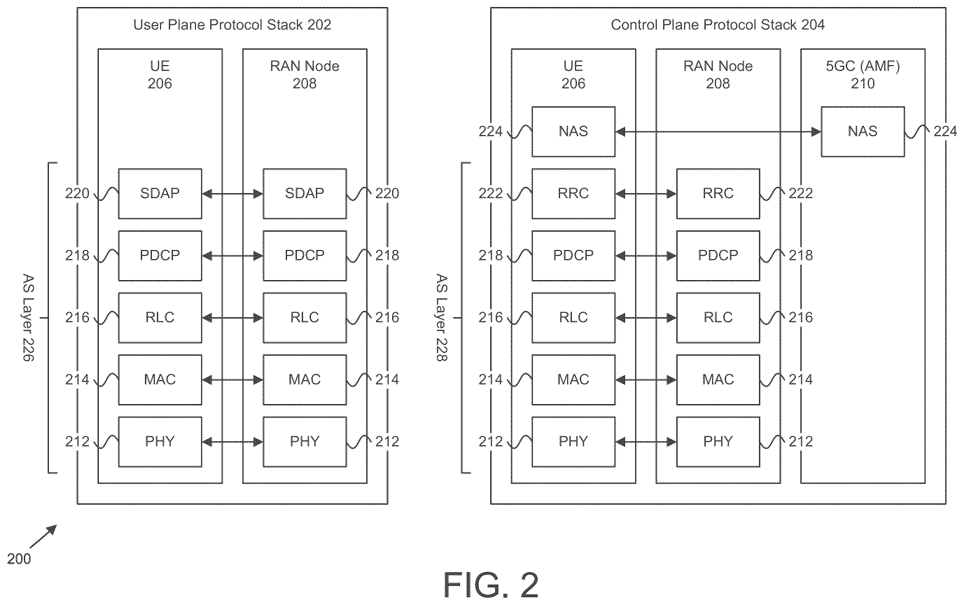

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP layer 220, PDCP sublayer 218, RLC sublayer 216, and MAC sublayer 214. The Layer-3 (L3) includes the RRC layer 222 and the NAS layer 224 for the control plane and includes, e.g., an Internet Protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 220, RRC layer 222 and NAS layer 224) and a transmission layer in Multiple-Input Multiple-Output (MIMO) communication (also referred to as a “MIMO layer” or a “data stream”).

Regarding RRC states, 3GPP defines three different RRC states/modes for 5G NR: RRC_IDLE, RRC_INACTIVE, and RRC_CONNECTED. Initially, i.e., upon powering up, the UE is in an idle mode corresponding to the RRC_IDLE state. Before performing data transfer (including placing calls), the UE must establish a connection with the network which is done using initial access via RRC connection establishment procedure. Once RRC connection is established, the UE is in the RRC_CONNECTED state. The RRC connection may be suspended due to inactivity, wherein the UE transitions to the RRC_INACTIVE state. Via the RRC release procedure, the RRC connection is released and the UE transitions to the RRC_IDLE state.

A network may configure a UE in the RRC_CONNECTED state to perform measurements. The network may configure the UE to report them in accordance with the measurement configuration or perform conditional reconfiguration evaluation in accordance with the conditional reconfiguration. The measurement configuration is provided by means of dedicated signaling, i.e., using the RRCReconfiguration or RRCResume.

The network may configure the UE to report the following measurement information based on SS/PBCH block(s): 1) Measurement results per SS/PBCH block; 2) Measurement results per cell based on SS/PBCH block(s); and 3) SS/PBCH block(s) indexes.

The measurement configuration includes the following parameters: 1) Measurement objects; 2) Reporting configurations; 3) Measurement identities; 4) Quantity configurations; and 5) Measurement gaps.

The measurement objects parameter measObject includes a list of one or more objects on which the UE shall perform the measurements. For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.

The parameter measObjectId of the measurement object which corresponds to each serving cell is indicated by servingCellMO within the serving cell configuration. For inter-radio access technology (RAT) Evolved Universal Terrestrial Radio Access (E-UTRA) measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting. For inter-RAT Universal Terrestrial Radio Access Frequency Division Duplexing (UTRA-FDD) measurements a measurement object is a set of cells on a single UTRA-FDD carrier frequency.

For NR sidelink measurements of L2 UE-to-Network (U2N) Relay UEs, a measurement object is a single NR sidelink frequency to be measured. For channel busy ratio (CBR) measurement of NR sidelink communication, a measurement object is a set of transmission resource pool(s) on a single carrier frequency for NR sidelink communication.

For CBR measurement of NR sidelink discovery, a measurement object is a set of discovery dedicated resource pool(s) or transmission resource pool(s) also used for NR sidelink discovery on a single carrier frequency for NR sidelink discovery. For cross-link interference (CLI) measurements a measurement object indicates the frequency/time location of sounding reference signal (SRS) resources and/or CLI received signal strength indicator (CLI-RSSI) resources, and subcarrier spacing of SRS resources to be measured.

The reporting configurations parameter is a list of one or more measurement reporting configurations, where there can be one or multiple reporting configurations per measurement object. In various embodiments, each measurement reporting configuration includes the following parameters: A) Reporting criterion; B) Reference Signal (RS) type; and C) Reporting format.

The reporting criterion parameter indicates the criterion that triggers the UE to send a measurement report. This can either be periodical or a single event description. The RS type parameter indicates the RS that the UE uses for beam and cell measurement results (SS/PBCH block or CSI-RS). The reporting format parameter indicates the quantities per cell and per beam that the UE includes in the measurement report (e.g., reference signal received power (RSRP)) and other associated information such as the maximum number of cells and the maximum number beams per cell to report.

In case of conditional reconfiguration, each configuration includes the following parameters: A) Execution criteria; and B) RS type. The execution criteria parameter indicates the criteria the UE uses for conditional reconfiguration execution. The RS type parameter indicates the RS that the UE uses for obtaining beam and cell measurement results (SS/PBCH block-based or CSI-RS-based), used for evaluating conditional reconfiguration execution condition.

In the measurement configuration, the measurement identities parameter indicates a list of one or more measurement identities where each measurement identity links one measurement object with one reporting configuration. By configuring multiple measurement identities, it is possible to link more than one measurement object to the same reporting configuration, as well as to link more than one reporting configuration to the same measurement object.

The measurement identity is also included in the measurement report that triggered the reporting, serving as a reference to the network. For conditional reconfiguration triggering, one measurement identity links to exactly one conditional reconfiguration trigger configuration. Up to two measurement identities can be linked to one conditional reconfiguration execution condition.

The quantity configurations parameter defines the measurement filtering configuration used for all event evaluation and related reporting, and for periodical reporting of that measurement. For NR measurements, the network may configure up to two quantity configurations with a reference in the NR measurement object to the configuration that is to be used. In each configuration, different filter coefficients can be configured for different measurement quantities, for different RS types, and for measurements per cell and per beam.

The measurement gaps parameter indicates the time periods that the UE may use to perform measurements.

A UE in RRC_CONNECTED maintains a measurement object list, a reporting configuration list, and a measurement identities list according to signaling and procedures in this specification. The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells: 1) The NR serving cell(s)—these are the special cells (SpCell), i.e., primary cell (PCell) and/or a primary secondary cell (PScell), and one or more SCells; 2) Listed cells—these are cells listed within the measurement object(s); or 3) Detected cells—these are cells that are not listed within the measurement object(s) but are detected by the UE on the SSB frequency (ies) and subcarrier spacing(s) indicated by the measurement object(s).

Based on the measurement configuration the network may generally know when the UE needs to measure an SCell and so it can already switch on the SSB transmission of an SCell (i.e., using backhaul signaling). Moreover, the UE can be provided an order of inter-frequency measurements—this feature is called measSequence and using this a UE can be given an order in which the frequencies should be measured.

As used herein, the parameter measSequence indicates the recommended sequence for intra/inter-RAT intra/inter-frequency measurement. Value 1 means the corresponding frequency is measured firstly. Value 2 means the corresponding frequency is measured secondly and so on. If more than one frequency is configured with the same value, it means no recommended sequence among these frequencies. If no value is provided, this indicates that there is no recommended sequence for the corresponding frequency. In certain embodiments, the parameter measSequence is only configured for NR standalone or if the parameter measObject is associated to the master cell group (MCG).

However, since the actual radio frequency (RF) measurements are left to UE implementation, network may still not know when the SCell SSB measurements are actually to be carried out in the UE.

According to aspects of a first solution, a network entity (NE) or a RAN device (e.g., MN or SN) indicates explicitly to UE (e.g., while configuring measurements) any measurement objects that contain at least one cell (e.g., SCell) not transmitting SSBs regularly, i.e., according to legacy SSB configuration. Such cells are referred to herein as calls having an irregular SSB transmission pattern. In addition, such a measurement object may be included as the first intra/inter-RAT intra/inter-frequency in the measSequence.

In the legacy 5G NR SSB configuration, the transmission of SS/PBCHs within an SS/PBCH set is confined to a 5 ms window. The maximum number of SS/PBCHs within an SS/PBCH set (i.e., within 5 ms period) is specified to be 4 for frequency ranges up to 3 GHZ, 8 for 3 to 6 GHz, or 64 for 6 to 52.6 GHz in order to achieve a trade-off between coverage and resource overhead. Furthermore, the number of actual transmitted SS/PBCHs is configurable and could be less than the maximum number. For this purpose, the SSB configuration uses the information elements (IEs) ssb-PositionsInBurst and ssb-periodicityServingCell (from 5 up to 160 ms, default of 5 ms if not configured). The UE may also be configured with the IE ssb-Position-QCL which indicates the quasi-co-location (QCL) relation between SSB positions for the cell (e.g., for operation with shared spectrum access).

Accordingly, upon receiving the measurement configuration, the UE shall start with the measurement of the first object, i.e., indicated as first according to the measSequence value. Alternatively, regardless of if a measSequence has been included for a measurement object, the UE prioritizes measurement of an object for which the network (e.g., MN or SN) explicitly indicates that a cell (e.g., an SCell) has an irregular SSB transmission patter (i.e., is not transmitting SSBs regularly). As part of the UE measurement prioritization process, the UE may start with the measurement of the explicitly indicated object before any other measurements.

Using the same logic, if there are more than one measurement objects each with at least one Cell (SCell) not transmitting SSBs regularly, then these are placed in measurement sequence before any other measurement object. In one example, if measSequence value is not included or the same measSequence value for these or a subset of measurement objects, there may be no priority or recommended sequence among these measurement objects associated with cells having irregular SSB transmission patterns. Alternatively, the priority among measurement objects associated with cells having irregular SSB transmission patterns may be in order of one or more of the configured SCell index (e.g., from lowest value to highest value), measurement object ID, measurement ID.

Moreover, the network ensures that the SSB transmission of the SSB-not-transmitting cell is ON, according to the SS/PBCH block Measurement Timing Configuration (SMTC) configuration(s) provided to the UE for a corresponding measurement object.

In an alternative implementation of the first solution, the network may indicate the number of measurement objects ‘n’ that contain containing at least one cell (e.g., SCell) associated with an irregular SSB transmission pattern (i.e., not transmitting SSBs regularly). This manifests into the first ‘n’ measSequences. In this implementation, the UE shall measure these (n) measurement objects first.

In various embodiments, if the UE needs measurement gaps for measurement and has been provided with measurement gaps, the gaps are used along with the corresponding received SMTC information to perform measurements (e.g., in order or priority as stipulated by the measSequence).

According to aspects of a second solution, upon receiving a measurement object having at least one cell associated with an irregular SSB transmission parameter, the UE signals a start time to measure a measurement object that has been indicated by the network as containing at least one Cell (SCell) not transmitting SSBs regularly. Similar to the first solution, there the network (MN or SN) indicates explicitly to the UE while configuring measurement objects that may contain at least one Cell (SCell) not transmitting SSBs regularly.

In one implementation of the second solution, the start time may be included in a UE Assistance information transmitted by the UE. In certain embodiments, the start time may be expressed as an offset, starting from the first subframe/slot after the transmission of UE Assistance information. The offset may be an integer multiple of Frame and/or subframe offset. Alternatively, the start time can be signaled as at least a SFN (System Frame Number) and optionally a slot/subframe number. When the start time is not included, the value ‘0’ is used.

In another implementation of the second solution, following reception of additional Assistance information from the network (e.g., in an acknowledgement (ACK) message), the UE may assume the SSB transmissions are present starting from a first SMTC occasion (e.g., last slot comprising the ACK+processing time) and that satisfy the SMTC occasion SFN and subframe condition according to the periodicity and offset parameters for the SMTC.

In one example, the UE may indicate in the UE Assistance information a preferred minimum number of measurement windows/SMTC occasions in which to receive SS/PBCH blocks (e.g., for time/frequency synchronization prior to start of measurements, or generally for measurements (e.g., including synchronization) to meet some performance accuracy/requirement).

In another example, ACK from the network may indicate the number of SMTC occasions (including until cancelled (e.g., by another signaling from the network)) starting from the first SMTC occasion the UE can assume the presence of SSB transmissions (e.g., no measurement/event evaluation after the last indicated SMTC occasion).

In one example, the number of SMTC occasions may be indicated in terms of number of averaged SS-blocks/CSI-RS-Resources measurements if the measurement object is configured with a maximum number of measurement results per beam based on SS/PBCH blocks/CSI-RS resources to be averaged (e.g., number of SMTC occasions=number of averaged SS-blocks/CSI-RS-Resources×maximum number of measurement results to be averaged). In some examples, the ACK from the network may include one or more of SMTC parameters e.g., periodicity, offset, duration, SSB to measure.

Once the measurement is started, the UE must finish the measurement within a time period-irrespective of if the UE implementation measures more than one frequencies/RATs in parallel. The time period e.g., 100 ms can be specified, or can be configured by the network along with the measurement configuration provided to the UE, or can be broadcasted. Alternatively, the UE uses the UE Assistance information to inform the network when the measurement of the measurement object (no-SSB-cell-frequency) is complete along with its measurement report. In one implementation, the reception of measurement report containing measurement result of the measurement object tells the network that the SSB of the cell (SCell) can be switched off.

From the network's perspective if there are more than one RRC Connected UEs required to measure the same SCell (or neighbor cell), their requested “time period” for SCell measurements may or may not overlap. Network however needs to ensure that each UE has sufficient SSB measurement opportunity and honor UE's request wherever possible. Network has some (but still limited) flexibility here since the measurement configuration should be done a priori, i.e., before UE's radio situation has really worsened. The network may still manage some energy saving with start/end of SSB transmission if the number of UEs using an SCell (not transmitting SSB) are limited, assuming this is still better than transmitting SSB like legacy.

As an enhancement, a UE may also want to signal a “periodicity”, included as part of “new information”, if it would measure the Object on regular basis to check if a measurement event will be fulfilled, this is otherwise up to UE implementation and only known to it, restricted only by performance requirement. In various embodiments, the network may accept UE's requested start time and periodicity and or signal back modified values-taking into account the overall situation.

If there are eventually many UEs configured to measure a SCell and each requiring quite varied start time and periodicities, minimizing network's energy saving gains, then network may use the following embodiments, or even go to legacy SSB transmission.

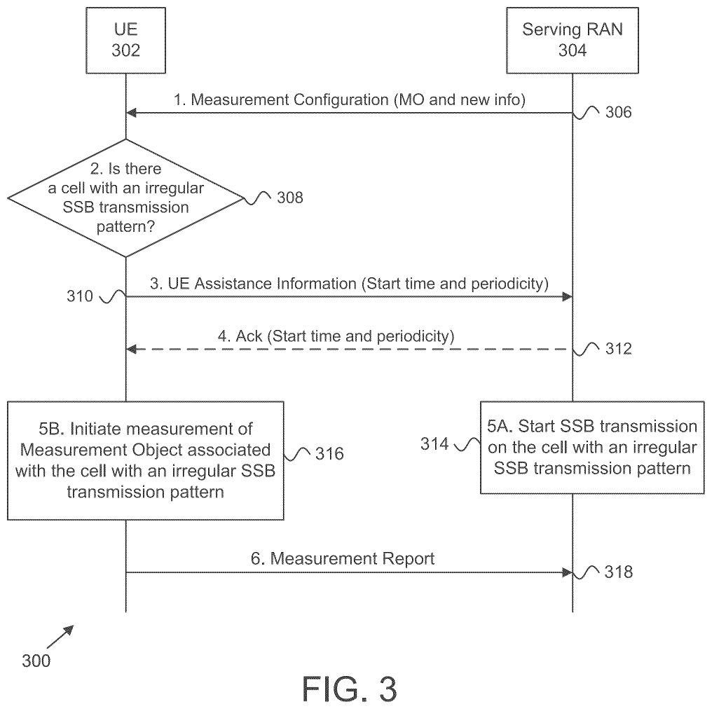

FIG. 3 illustrates an exemplary procedure 300 for #, in accordance with aspects of the present disclosure. The procedure 300 involves a UE 302 (e.g., in an RRC_CONNECTED state) and a serving network 304 comprising at least one energy saving cell and a serving cell that acts as an anchor cell for the energy saving cell(s). In certain embodiments, the UE 302 is an embodiment of a UE 104. In certain embodiments, the first and serving network comprises a RAN with a set of NEs 102. In one embodiment, the anchor cell and the energy saving cell(s) belong to the same base station (e.g., same gNB). In another embodiment, the anchor cell and the energy saving cell(s) belong to different base stations (e.g., different gNBs).

The procedure 300 begins at step 1 as the serving network 304 transmits a measurement configuration to the UE 302 (see signaling 306). As disclosed above, the measurement configuration includes a set of one or more measurement object and additional “new” information. Here, at least one measurement object includes a cell with an irregular SSB transmission pattern (e.g., the energy saving cell). Accordingly, the new information in the measurement configuration includes an indication that a particular measurement object contains at least one cell not transmitting SSBs regularly. In certain embodiments, the new information indicates that measurement of the energy saving cell should be performed first, e.g., using a measSequence value.

At step 2, the UE 302 determines whether the measurement configuration includes a cell not transmitting SSB (i.e., an energy saving cell with an irregular SSB transmission pattern) (see decision block 308). In the procedure 300, it is assumed that the UE 302 recognizes the indication that a particular measurement object contains at least one cell not transmitting SSBs regularly.

At step 3, the UE 302 transmits UE Assistance information to the serving network 304 (see signaling 310). As mentioned above, UE Assistance information includes a start time and a periodicity associated with the UE measurements of the measurement object contains at least one cell not transmitting SSBs regularly.

At optional step 4, the serving network 304 may transmit an Acknowledgement (ACK) to the UE 302 (see signaling 312). In certain embodiments, the ACK includes additional Assistance information, such as a modified start time and/or periodicity associated with the SSB transmissions on the energy saving cell.

At step 5A, the serving network 304 starts/activates SSB transmission at the cell not transmitting SSBs regularly (see block 314). In certain embodiments, the serving network 304 adjusts the irregular SSB transmission pattern of the particular cell so that SSB transmission occurs according to the start time and periodicity indicated in the UE Assistance information.

At step 5B, the UE 302 initiates measurement of the measurement object containing at least one cell not transmitting SSBs regularly (see block 316). In one embodiment, the UE 302 initiates the measurement according to the start time and periodicity indicated in the UE Assistance information or a modified start time and/or periodicity indicated in the additional Assistance information received from the serving network 304.

At step 6, the UE 302 transmits a measurement report to the serving network 304 (see signaling 318).

According to aspects of the third solution, to support energy saving cells, the network may configure a cell SSB-DTX pattern which is a pattern of time periods when SSB is transmitted (active time) and time periods when SSB is not transmitted (not-active or SSB-sleep time). Using this pattern, the network informs UEs when SSB will and will not be transmitted by otherwise non-SSB transmitting cell of a certain measurement object. The pattern is configured (and released) using RRC signaling and activated and deactivated by L1 signaling-which can be UE specific, i.e., addressing UE specific C-RNTI or it can be designed to be group common i.e., likely using a reserved RNTI or an RNTI configured to a plurality of UEs (e.g., RRC Connected UEs).

The UEs attempt measurement of the measurement object only when the cell is in SSB transmission (active) state (and during the configured SMTC occasions). To this end, UE needs to make an AND operation between the received SMTC configuration and the SSB-DTX active period to plan its measurement of the corresponding measurement object. The RRC signaling configuring SSB-DTX pattern may activate or deactivate the pattern directly upon RRC configuration/deconfiguration.

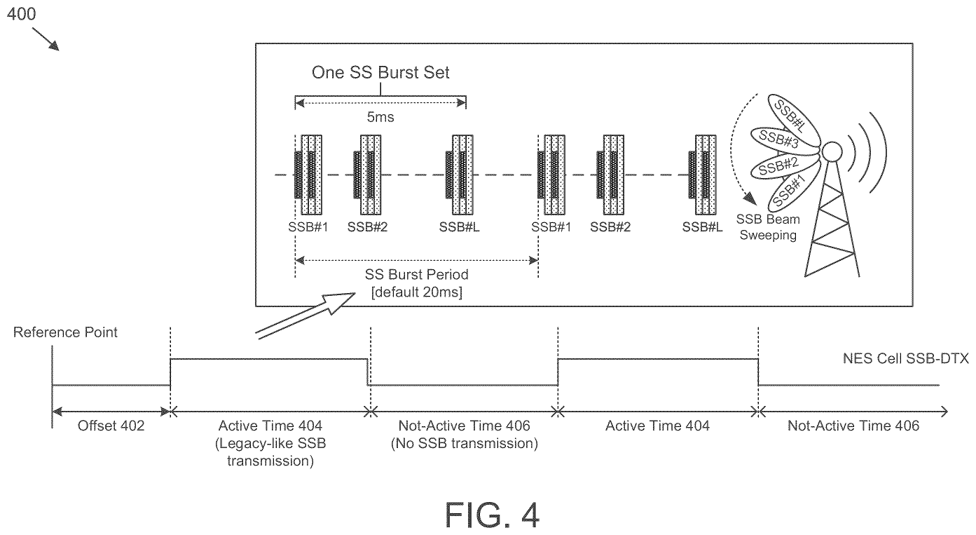

FIG. 4 illustrates an exemplary SSB-DTX pattern 400 for an energy-saving cell, in accordance with aspects of the present disclosure. The SSB-DTX pattern 400 includes an offset 402 from a reference point. After the offset 402, an Active time 404 begins wherein the cell performs SSB transmission for a first period of time, after which a Non-active time 406 begins. During the Non-active time 406 (also referred to a SSB-sleep time) the cell does not perform SSB transmission for a second period of time. The Active time 404 and the Non-active time 406 form a cycle.

The SSB transmissions during the Active time 404 follow the legacy behavior of one or multiple synchronization signal (SS) burst transmissions over a first period, referred to as a SS Burst Set. An SS burst set comprised of a set of one or more SSBs, each SSB potentially transmitted on a different beam. The SSBs in the SS burst set are transmitted in time-division multiplexing fashion over a 5 ms window. The SS burst set is repeated according to the SSB periodicity (e.g., 20 ms), thereby forming the SS burst period.

As depicted, an SSB transmission may include a first SS (e.g., primary SS) in a first time-domain symbol (e.g., OFDM symbol), a PBCH transmission in a second time-domain symbol, a second SS (e.g., secondary SS) and PBCH transmission in a third time-domain symbol, and a PBCH transmission in a fourth time-domain symbol. To support beam sweeping, the RAN entity (e.g., gNB) may change a beam direction for each SSB transmission of the SS burst set.

In various embodiments, the duration of the Active time 404 is significantly longer than the SS burst period, thereby allowing for transmission of multiple SS burst sets over multiple SS burst periods during the Active time 404.

In a first example, SSB is transmitted in periods corresponding to an intersection of active periods of SSB-DTX pattern, with active periods of cell DTX (defined below) corresponding to the SCell (e.g., only during cell active periods).

In a second example, SSB is transmitted in periods corresponding to either active periods of SSB-DTX pattern, or active periods of cell DTX corresponding to the SCell when SSB-DTX is not configured.

Regarding the cell DTX, to facilitate reducing gNB downlink transmission/uplink reception active time, UE can be configured with a periodic cell DTX and/or Discontinuous Reception (DRX) pattern (i.e., active and non-active periods). The pattern configuration for cell DTX/DRX is common for the UEs configured with this feature in the cell. The cell DTX and cell DRX patterns can be configured and activated separately. A maximum of two cell DTX/DRX patterns can be configured per MAC entity for different serving cells.

When cell DTX is configured and activated for the concerned cell, the UE may not monitor PDCCH in selected cases or does not monitor semi-persistent scheduling (SPS) occasions during cell DTX non-active duration. When cell DRX is configured and activated for the concerned cell, the UE does not transmit on configured grant (CG) resources or does not transmit a scheduling request (SR) during cell DRX non-active duration. This feature is only applicable to UEs in RRC_CONNECTED state and it does not impact Random Access (RACH) procedure, SSB transmission, paging, and system information broadcasting.

Similar to the cell SSB-DTX pattern described above, the cell DTX/DRX can be activated/deactivated by RRC signaling or L1 group common signaling. The cell DTX/DRX is characterized by the following: A) active duration (i.e., the duration that the UE waits for to receive PDCCHs or SPS occasions, and transmit SR or CG); and B) cycle (i.e., specifies the periodic repetition of the active-duration followed by a period of non-active duration). During the active duration of the cell DTX/DRX, the gNB transmission/reception of PDCCH, SPS, SR, CG, periodic and semi-persistent channel state information (CSI) report are not impacted for the purpose of network energy saving. Active duration and cycle parameters are common between cell DTX and cell DRX, when both are configured.

Once the gNB recognizes there is an emergency call or public safety related service (e.g., multimedia priority service (MPS) or mission-critical service (MCS)), the network should ensure that there is no impact to that service (e.g. it may release or deactivate cell DTX/DRX configuration and the cell SSB-DTX configuration). The network should also ensure that there is at least partial overlapping between UE's connected mode DRX on-duration and cell DTX/DRX active duration, i.e., the UE's connected mode DRX periodicity is a multiple of cell DTX/DRX periodicity or vice versa.

According to aspects of the fourth solution, to support energy saving cells, the network may use and modify the existing cell activation and deactivation concept, as defined in 3GPP Technical Specification (TS) 38.300 and 3GPP TS 38.321. To enable reasonable UE battery consumption when carrier aggregation (CA) is configured, an activation/deactivation mechanism of Cells is supported. When an SCell is deactivated, the UE does not need to receive the corresponding PDCCH or PDSCH, cannot transmit in the corresponding uplink, nor is it required to perform channel quality indicator (CQI) measurements.

Conversely, when an SCell is active, the UE shall receive PDSCH and PDCCH (if the UE is configured to monitor PDCCH from this SCell) and is expected to be able to perform CQI measurements. The next generation radio access network (NG-RAN) ensures that while Physical Uplink Control Channel (PUCCH) SCell (i.e., a Secondary Cell configured with PUCCH) is deactivated, SCells of the secondary PUCCH group (i.e., a group of SCells whose PUCCH signaling is associated with the PUCCH on the PUCCH SCell) should not be activated. The NG-RAN ensures that SCells mapped to PUCCH SCell are deactivated before the PUCCH SCell is changed or removed.

To save energy in the network, a new concept of SSB-activation and SSB-deactivation can be used, whereby the UE is informed using MAC control element (CE) or downlink control information (DCI) when and for which SCell(s) SSB SSB-activation and SSB-deactivation are to be applied immediately. When an SCell is SSB-deactivated, the UE still has to receive the corresponding PDCCH or PDSCH, can transmit in the corresponding uplink, and it may be required to perform CQI measurements. Only radio resource management (RRM) measurements on SSB-RS are not required to be made.

With regards to all non-SSB channels (e.g., PDCCH, PDSCH, Physical Uplink Shared Channel (PUSCH), PUCCH, etc.), the UE follows the legacy cell activation and deactivation procedure. In some examples, the cell activation/deactivation and SSB activation/deactivation may be indicated in the same MAC CE or DCI (e.g., jointly coded). With regards to SSB reception at a UE, it can receive/measure SSB of an on-demand SSB cell (or not regularly SSB transmitting cell) only when the SSB-activation is in effect (i.e., SSB-activation MAC CE has been most recently received-last slot of PDSCH comprising MAC CE+processing time), or SSB-deactivation MAC CE has not been received) and the SCell is not considered deactivated. RRC Configuration can be used to activate/deactivate SSB of a SCell when configuring the cell or upon handover or upon RRC Connection resumption.

In one example implementation, a serving cell configuration for a UE includes a configuration for semi-persistent SSB, indicating that the serving cell transmits SSB semi-persistently based on an activation/deactivation command. If the serving cell is configured as a secondary serving cell (SCell) for the UE and if the SCell is deactivated for the UE, the UE performs measurement on the SCell only upon receiving the activation command and for the duration of active SSB transmission. If the SCell is activated for the UE, the UE performs measurement on the SCell according to a corresponding measurement and reporting configuration(s).

In another example implementation, a measurement configuration includes information of a set of associated cells, where a measurement report for a first cell of the set of associated cells implicitly indicates a request for SSB transmission in a second cell of the set of associated cells. For example, if the first and second cells are configured as a primary serving cell (PCell) and SCell for a UE, respectively, and if the UE observes degradation of radio link quality (e.g. RSRP lower than a threshold value) on the PCell, the UE sends a measurement report (e.g. event-triggered) to the PCell and expects to measure the SCell on SSB occasions of the SCell, which occur a predefined or configured time after transmitting the measurement report.

The measurement report may correspond to an SSB SCell request signal. In one example, the SSB SCell request is transmitted over PUCCH, and is multiplexed with at least one of Hybrid Automatic Repeat Request (HARQ) ACK, SR and CSI report. In one example, a SCell index associated to the SSB SCell request may be included in the report. In another example, SSB SCell request corresponds to an SR over PUCCH or uplink control information (UCI) of PUSCH, wherein an identifier, e.g., SchedulingRequestID-SSB-SCell, indicates a configuration of the scheduling request, wherein an uplink resource allocation associated with the SSB SCell request-related SR is set to “null”.

UE cancels the SR triggered by the SSB SCell request to avoid UE repeating the SR transmission until max number of SR is reached and Radio link failure is finally triggered. In one implementation this could be done as an UL grant with UL resource allocation set to “null” is received. As another possibility, SSB reception from the requested cell is used to cancel the SR trigger.

According to aspects of the fifth solution, to support energy saving cells, the network may support the on-demand provisioning of System Information (SI) of an SCell—or a non-serving cell—to a UE in the RRC_Connected state. In one embodiment, a new RRC Dedicated SIB Request message can be used for the on-demand provisioning of SI. Alternatively, the RRC message DedicatedSIBRequest may be reused for this purpose. In either case the SIB request message for the on-demand provisioning of SI shall contain details of cell, e.g., Physical Cell Identity and/or Frequency, and list of requested System Information Blocks.

In various embodiments, the on-demand provisioning of SI can be used by the UE for cells indicated as not providing SIB1 and/or other SIB(s) regularly—indication included in the SCell configuration while the SCell is being added, or in neighbor carrier/cell list in System information block #3 (SIB3), System information block #4 (SIB4), System information block #5 (SIB5) for intra-frequency, inter-frequency, and inter-RAT cells respectively. The requested SIB(s) of one or more cells, can be provided to the UE in dedicated RRC message by the serving cell. Alternatively, upon receiving the dedicated request, the serving cell may respond to the UE indicating that the requested SIB(s) of the requested Cell(s) are now being broadcasted.

Using a response message, which could be RRC message, L2 ACK or HARQ ACK (e.g., reception of an UL grant with a new data indicator (NDI) provided in the associated HARQ information toggled compared to the value in the transmission including the dedicated request for the same HARQ process), a handshake of the SIB request message can be assumed or considered successful, and UE may assume that the requested SIB1 is now being broadcasted.

In certain embodiments, the new/enhanced dedicated SIB Request need not contain any SIB information if the UE only intends to receive SIB1 of the cell included in the Request message. Alternatively, UE may not even need to indicate the cell information if the Request message is sent to the serving cell for which the UE is demanding the SIB1.

In certain embodiments, the new/enhanced dedicated SIB Request can be transmitted by the UE irrespective of if the UE is in the RRC_CONNECTED state with an active bandwidth part (BWP) not configured with common search space (CSS), e.g., using the field searchSpace OtherSystemInformation.

Note that the techniques described herein for SSB and SIB request, can also be used to request CSI-RS resources (e.g., CSI-RS resources for mobility).

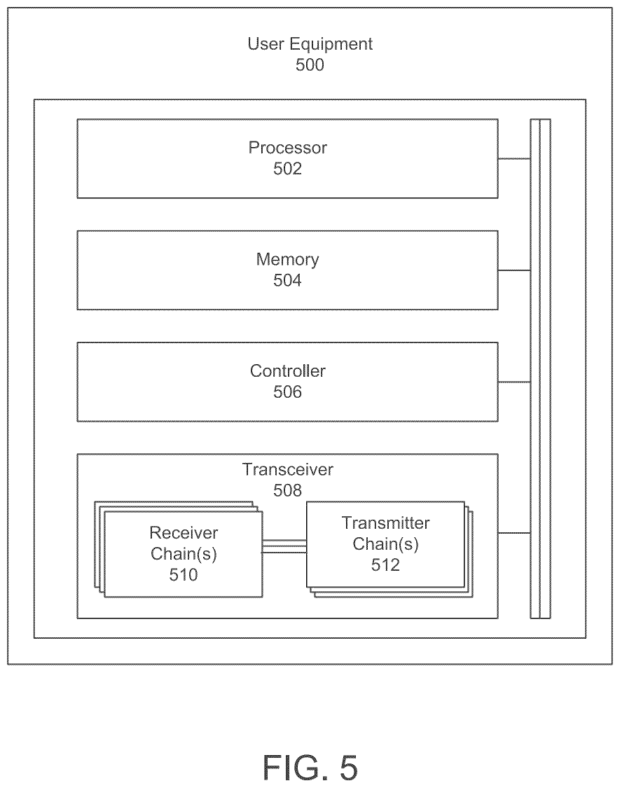

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform various function (e.g., operations, signaling) described herein (e.g., executing, by the processor 502, instructions stored in the memory 504). In some implementations, the processor 502 may include multiple processors and the memory 504 may include multiple memories. One or more of the multiple processors may be coupled with one or more of the multiple memories, which may be individually or collectively, configured to perform various functions (e.g., operations, signaling) of the UE 500 as described herein.

The processor 502 coupled with the memory 504 may be configured to, capable of, or operable to cause the UE 500 to receive, from a serving RAN, a measurement configuration (e.g., contained in RRC Connection Reconfiguration message) comprising a first measurement object corresponding to a first cell associated with an irregular SSB transmission pattern.

The processor 502 coupled with the memory 504 may be configured to, capable of, or operable to cause the UE 500 to identify a set of measurement objects and prioritize a measurement of the first measurement object, e.g., based on the received measurement configuration. In some implementations, the first measurement object comprises a channel frequency number of the first cell. In some implementations, the first cell is a SCell.

The processor 502 coupled with the memory 504 may be configured to, capable of, or operable to cause the UE 500 to transmit measurement assistance information for the measurement object, where the measurement assistance information includes a start time and a periodicity value. In some implementations, the start time is a time offset expressed in milliseconds, number of slots or subframes. In some implementations, the periodicity value indicates how often the UE 500 is to measure the measurement object.

The processor 502 coupled with the memory 504 may be configured to, capable of, or operable to cause the UE 500 to perform one or more measurements of the measurement object and a means for transmitting a measurement report comprising the one or more measurements. In some implementations, the measurement configuration indicates a physical cell identity and an SMTC corresponding to the physical cell identity. In certain implementations, the SMTC may include a time duration for indicating a maximum time of SSB transmission. In such implementations, the processor 502 coupled with the memory 504 may be configured to, capable of, or operable to cause the UE 500 to complete the one or more measurements of the measurement object within the indicated time duration.

In some other implementations, the processor 502 coupled with the memory 504 may be configured to, capable of, or operable to cause the UE 500 to receive, from a serving RAN, a configuration for a first cell associated with an irregular SSB transmission pattern. In some implementations, the first cell corresponds to an on-demand cell and the irregular SSB transmission pattern corresponds to a semi-persistent SSB transmission pattern.

The processor 502 coupled with the memory 504 may be configured to, capable of, or operable to cause the UE 500 to receive an indication for activation of SSB transmissions for the first cell. In certain implementations, the indication for activation comprises an RRC message. In certain other implementations, the configuration may be an RRC message, and the indication for activation may be a MAC-CE.

In some implementations, the configuration may include information of a set of cells comprising the first cell. In some implementations, the indication comprises an SSB activation/deactivation indication that is jointly coded with a cell activation/deactivation indication corresponding to the first cell.

The processor 502 coupled with the memory 504 may be configured to, capable of, or operable to cause the UE 500 to perform one or more measurements in accordance with the configuration. In some implementations, the processor 502 coupled with the memory 504 may be configured to, capable of, or operable to cause the UE 500 to receive a second indication for deactivation of the SSB transmission; and cease performing the one or more measurements in response to the deactivation of the SSB transmission.

The processor 502 coupled with the memory 504 may be configured to, capable of, or operable to cause the UE 500 to determine a duration of active SSB transmission based at least in part on the configuration; and perform the one or more measurements in response to the indication for activation and during the duration of active SSB transmission.

In some implementations, the processor 502 coupled with the memory 504 may be configured to, capable of, or operable to cause the UE 500 to transmit a first measurement report comprising the one or more measurements associated with the first cell.

In some implementations, the processor 502 coupled with the memory 504 may be configured to, capable of, or operable to cause the UE 500 to transmit a second measurement report for a second cell from the set of cells; and receive the indication for activation of the SSB transmission in response to the second measurement report.

In certain implementations, the first cell corresponds to a secondary cell and the second cell corresponds to a primary cell. In such implementations, the second measurement report may indicate a degraded radio link quality on the primary cell.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

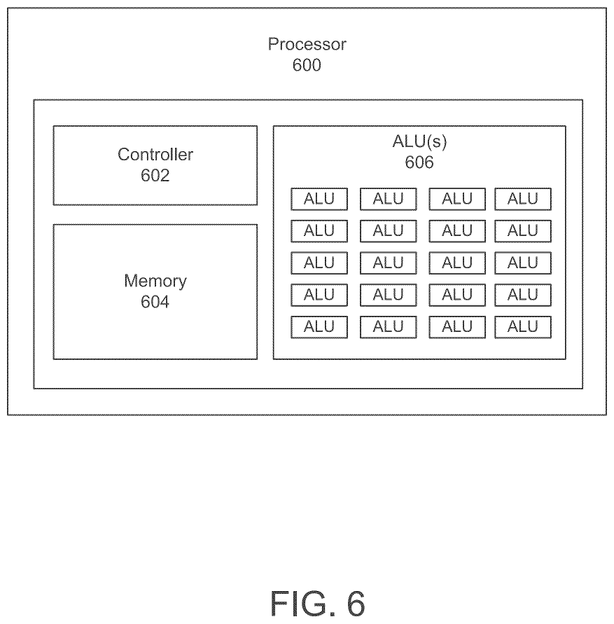

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In certain implementations, the processor 600 may support various functions (e.g., operations, signaling) of a UE, in accordance with examples as disclosed herein. For example, the controller 602 coupled with the memory 604 may be configured to, capable of, or operable to cause the processor 600 to receive, from a serving RAN, a measurement configuration (e.g., contained in RRC Connection Reconfiguration message) comprising a first measurement object corresponding to a first cell associated with an irregular SSB transmission pattern. The controller 602 coupled with the memory 604 may be configured to, capable of, or operable to cause the processor 600 to transmit measurement assistance information for the measurement object, where the measurement assistance information includes a start time and a periodicity value. The controller 602 coupled with the memory 604 may be configured to, capable of, or operable to cause the processor 600 to perform one or more measurements of the measurement object and a means for transmitting a measurement report comprising the one or more measurements.

In certain other implementations, the controller 602 coupled with the memory 604 may be configured to, capable of, or operable to cause the processor 600 to receive, from a serving RAN, a configuration for a first cell associated with an irregular SSB transmission pattern; receive an indication for activation of SSB transmissions for the first cell; perform one or more measurements based on an SSB transmission associated with the first cell and in accordance with the configuration. Additionally, the controller 602 coupled with the memory 604 may be configured to, capable of, or operable to cause the processor 600 to perform one or more functions (e.g., operations, signaling) of the UE as described herein.

In some other implementations, the processor 600 may support various functions (e.g., operations, signaling) of a NE (e.g., base station), in accordance with examples as disclosed herein. For example, the controller 602 coupled with the memory 604 may be configured to, capable of, or operable to cause the processor 600 to transmit a measurement configuration (e.g., contained in RRC Connection Reconfiguration message) comprising a measurement object corresponding to a first cell associated with an irregular SSB transmission pattern. The controller 602 coupled with the memory 604 may be configured to, capable of, or operable to cause the processor 600 to receive measurement assistance information for the measurement object, the measurement assistance information comprising a start time and a periodicity value. The controller 602 coupled with the memory 604 may be configured to, capable of, or operable to cause the processor 600 to adjust the irregular SSB transmission pattern based at least in part on the measurement assistance information.

In yet other implementations, the controller 602 coupled with the memory 604 may be configured to, capable of, or operable to cause the processor 600 to transmit a configuration for a serving cell associated with an irregular SSB transmission pattern; transmit an indication for activation of SSB transmissions for the serving cell; and broadcast at least one SSB transmission in the serving cell in accordance with the configuration. Additionally, the controller 602 coupled with the memory 604 may be configured to, capable of, or operable to cause the processor 600 to perform one or more functions (e.g., operations, signaling) of the NE as described herein.

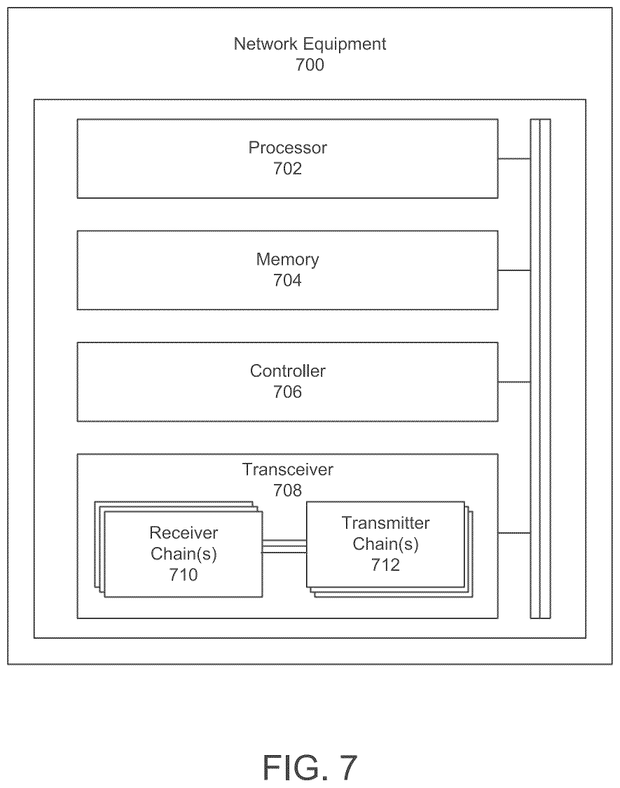

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform various functions (e.g., operations, signaling) described herein (e.g., executing, by the processor 702, instructions stored in the memory 704). In some implementations, the processor 702 may include multiple processors and the memory 704 may include multiple memories. One or more of the multiple processors may be coupled with one or more of the multiple memories, which may be individually or collectively, configured to perform various functions (e.g., operations, signaling) of the NE 700 as described herein.

The processor 702 coupled with the memory 704 may be configured to, capable of, or operable to cause the NE 700 to transmit a measurement configuration (e.g., contained in RRC Connection Reconfiguration message) comprising a measurement object corresponding to a first cell associated with an irregular SSB transmission pattern. In some implementations, the measurement configuration comprises at least one additional measurement object and a sequence for measurement (e.g., MeasSequence). In such implementations, the sequence for measurement may prioritize the first cell over a second cell associated with a regular SSB transmission pattern.

The processor 702 coupled with the memory 704 may be configured to, capable of, or operable to cause the NE 700 to receive measurement assistance information for the measurement object, the measurement assistance information comprising a start time and a periodicity value. In some implementations, the measurement assistance information comprises a minimum number of measurement windows (i.e., SMTC occasions).

In some implementations, the start time indicates an offset from a first subframe or slot subsequent to a reception of the measurement assistance information. In certain implementations, the offset is expressed in milliseconds, number of slots or subframes. In some implementations, the periodicity value indicates how often the UE intends to measure the measurement object.

The processor 702 coupled with the memory 704 may be configured to, capable of, or operable to cause the NE 700 to transmit an acknowledgement message in response to a reception of the measurement assistance information. In certain implementations, the acknowledgement message may include a set of timing configuration values, including one or more of: A) a transmission periodicity; B) a transmission offset value; C) a transmission duration; D) an SSB for measuring; E) a number of measurement windows (i.e., SMTC occasions); or a combination thereof.

The processor 702 coupled with the memory 704 may be configured to, capable of, or operable to cause the NE 700 to support a means for adjusting the irregular SSB transmission pattern based at least in part on the measurement assistance information.

In some implementations, to adjust the irregular SSB transmission pattern, the processor 702 coupled with the memory 704 may be configured to, capable of, or operable to cause the NE 700 to transmit SSB in the first cell in accordance with the start time and the periodicity value. The NE 700 may be further configured to start a timer corresponding to a maximum time of a SSB transmission and to pause the SSB transmission until a next period based at least in part on an expiry of the timer.

In certain implementations, to adjust the irregular SSB transmission pattern, the processor 702 coupled with the memory 704 may be configured to, capable of, or operable to cause the NE 700 to receive a measurement report associated with the measurement object and to pause SSB transmission until the next period in response to the measurement report.

In some implementations, the processor 702 coupled with the memory 704 may be configured to, capable of, or operable to cause the NE 700 to configure a discontinuous transmission pattern for the first cell based at least in part on the measurement assistance information, where the discontinuous transmission pattern comprises an offset, an active time, and a sleep time. In such implementations, the processor 702 coupled with the memory 704 may be configured to, capable of, or operable to cause the NE 700 to transmit an indication of the discontinuous transmission pattern to a UE.

In certain implementations, the processor 702 coupled with the memory 704 may be configured to, capable of, or operable to cause the NE 700 to determine the discontinuous transmission pattern for the first cell based at least in part on one or more of: A) the measurement assistance information; B) a total cell load; C) additional assistance information associated with one or more additional UEs; or a combination thereof.

Note that in some instances the current irregular pattern may meet a respective UE's needs and so no adjustment is made. For example, the NE 700 might also be transmitting SSBs to other UEs-which may already have some overlap with the particular UE's SSB request. In such a case, the SSB is already being transmitted when the particular UE needs it, so the actual transmission may not need any adjustment.

In some implementations, the processor 702 coupled with the memory 704 may be configured to, capable of, or operable to cause the NE 700 to determine a set of one or more modified measurement assistance values based at least in part on the received measurement assistance information. In such implementations, the processor 702 coupled with the memory 704 may be configured to, capable of, or operable to cause the NE 700 to transmit the set of one or more modified measurement assistance values in response to a reception of the measurement assistance information.

In some implementations, the processor 702 coupled with the memory 704 may be configured to, capable of, or operable to cause the NE 700 to receive an indication that a measurement of the first cell is complete. In such implementations, the NE 700 may be further configured to stop SSB transmission in the first cell based on the indication.

In some implementations, the processor 702 coupled with the memory 704 may be configured to, capable of, or operable to cause the NE 700 to receive a system information request message for a non-serving cell from a UE, where the system information request message comprises a physical cell identity or frequency, or both, and a list of requested SIBs. In certain implementations, the processor 702 coupled with the memory 704 may be configured to, capable of, or operable to cause the NE 700 to transmit, to the UE, a RRC message comprising a set of SIBs based on the system information request message.

In some other implementations, the processor 702 coupled with the memory 704 may be configured to, capable of, or operable to cause the NE 700 to transmit a configuration for a serving cell associated with an irregular SSB transmission pattern. In some implementations, the serving cell corresponds to an on-demand cell and the irregular SSB transmission pattern corresponds to a semi-persistent SSB transmission pattern.

The processor 702 coupled with the memory 704 may be configured to, capable of, or operable to cause the NE 700 to transmit an indication for activation of SSB transmissions for the serving cell. In certain implementations, the indication for activation comprises an RRC message. In certain other implementations, the configuration may be an RRC message, and the indication for activation may be a MAC-CE.

In some implementations, the processor 702 coupled with the memory 704 may be configured to, capable of, or operable to cause the NE 700 to broadcast at least one SSB transmission in the serving cell in accordance with the configuration. In some implementations, the processor 702 coupled with the memory 704 may be configured to, capable of, or operable to cause the NE 700 to transmit a second indication for deactivation of the SSB transmission; and cease the transmission of the SSB transmission.

The processor 702 coupled with the memory 704 may be configured to, capable of, or operable to cause the NE 700 to receive a measurement report based on the SSB transmission and in accordance with the configuration. In some implementations, the configuration may include information of a set of cells comprising the serving cell.

In some implementations, the processor 702 coupled with the memory 704 may be configured to, capable of, or operable to cause the NE 700 to receive a measurement report for a first cell from the set of cells; and transmit the indication for activation of the SSB transmission in response to a reception of the measurement report. In certain implementations, the first cell corresponds to a primary cell and the serving cell corresponds to a secondary cell. In such implementations, the measurement report may indicate a degraded radio link quality on the primary cell.

In some implementations, the processor 702 coupled with the memory 704 may be configured to, capable of, or operable to cause the NE 700 to receive a system information request message for a non-serving cell from a UE; and transmit the indication for activation of the SSB transmission in response to the system information request message. In such implementations, the system information request message comprises a physical cell identity or frequency, or both, and a list of requested SIBs.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

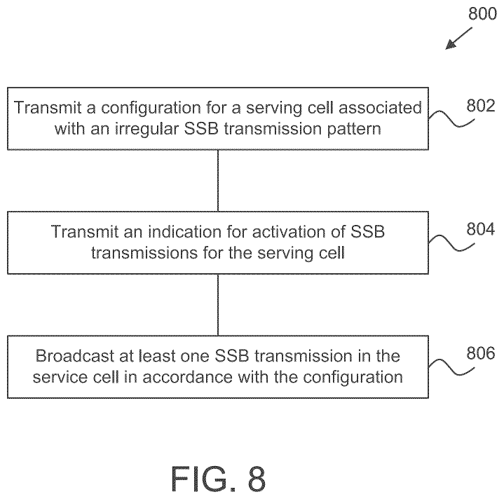

FIG. 8 illustrates one implementation of a method 800 in accordance with aspects of the present disclosure. In various implementations, the operations of the method 800 may be implemented by a NE as described herein. In some implementations, the NE may execute a set of instructions to control the function elements of the NE to perform the described functions.

At step 802, the method 800 may include transmitting a configuration for a serving cell associated with an irregular SSB transmission pattern. The operations of step 802 may be performed in accordance with examples as described herein. In some implementations, aspects of the operation of step 802 may be performed by a NE, as described with reference to FIG. 7.

At step 804, the method 800 may include transmitting an indication for activation of SSB transmissions for the serving cell. The operations of step 804 may be performed in accordance with examples as described herein. In some implementations, aspects of the operation of step 804 may be performed by a NE, as described with reference to FIG. 7.

At step 806, the method 800 may include broadcasting at least one SSB transmission in the serving cell in accordance with the configuration. The operations of step 806 may be performed in accordance with examples as described herein. In some implementations, aspects of the operation of step 806 may be performed by a NE, as described with reference to FIG. 7.

It should be noted that the method 800 described herein describes one possible implementation, and that the operations and the steps may be rearranged or otherwise modified and that other implementations are possible.

It should be noted that the method 800 described herein describes one possible implementation, and that the operations and the steps may be rearranged or otherwise modified and that other implementations are possible.

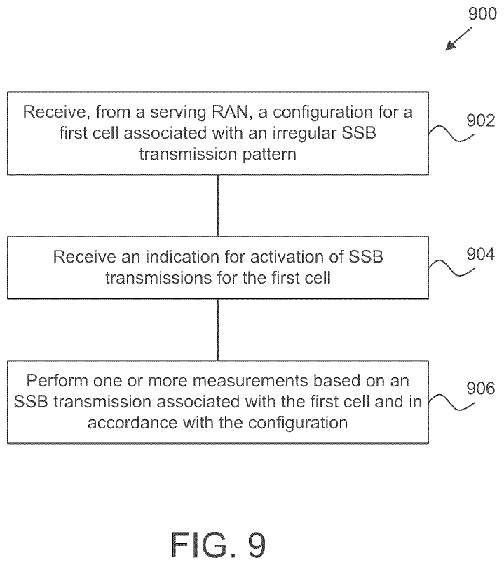

FIG. 9 illustrates one implementation of a method 900 in accordance with aspects of the present disclosure. The operations of the method 900 may be implemented by a UE as described herein. In some implementations, the UE may execute a set of instructions to control the function elements of the UE to perform the described functions.

At step 902, the method 900 may include receiving, from a serving RAN, a configuration for a first cell associated with an irregular SSB transmission pattern. The operations of step 902 may be performed in accordance with examples as described herein. In some implementations, aspects of the operations of step 902 may be performed by a UE, as described with reference to FIG. 5.

At step 904, the method 900 may include receiving an indication for activation of SSB transmissions for the first cell. The operations of step 904 may be performed in accordance with examples as described herein. In some implementations, aspects of the operations of step 904 may be performed by a UE, as described with reference to FIG. 5.

At step 906, the method 900 may include performing one or more measurements based on an SSB transmission associated with the first cell and in accordance with the configuration. The operations of step 906 may be performed in accordance with examples as described herein. In some implementations, aspects of the operations of step 906 may be performed by a UE, as described with reference to FIG. 5.

It should be noted that the method 900 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
at least one memory; and
at least one processor coupled with the at least one memory and configured to cause the base station to:
transmit a configuration for a serving cell associated with an irregular synchronization signal block (SSB) transmission pattern;
transmit an indication for activation of SSB transmissions for the serving cell; and
broadcast at least one SSB transmission in the serving cell in accordance with the configuration.

2. The base station of claim 1, wherein the configuration comprises a radio resource control (RRC) message, and wherein the indication for activation comprises a medium access control (MAC) control element (MAC-CE).

3. The base station of claim 1, wherein the indication for activation comprises a radio resource control (RRC) message.

4. The base station of claim 1, wherein the serving cell corresponds to an on-demand cell and the irregular SSB transmission pattern corresponds to a semi-persistent SSB transmission pattern.

5. The base station of claim 1, wherein the at least one processor is configured to cause the base station to:
transmit a second indication for deactivation of the SSB transmission; and
cease the transmission of the SSB transmission.

6. The base station of claim 1, wherein the configuration comprises information of a set of cells comprising the serving cell, and wherein the at least one processor is configured to cause the base station to:
receive a measurement report for a first cell from the set of cells; and
transmit the indication for activation of the SSB transmission in response to a reception of the measurement report.

7. The base station of claim 6, wherein the first cell corresponds to a primary cell and the serving cell corresponds to a secondary cell, and wherein the measurement report indicates a degraded radio link quality on the primary cell.

8. The base station of claim 1, wherein the at least one processor is configured to cause the base station to:
receive a system information request message for a non-serving cell from a user equipment (UE); and
transmit the indication for activation of the SSB transmission in response to the system information request message,
wherein the system information request message comprises a physical cell identity or frequency, or both, and a list of requested System Information Blocks (SIBs).

9. A user equipment (UE) for wireless communication, comprising:
at least one memory; and
at least one processor coupled with the at least one memory and configured to cause the UE to:
receive, from a serving radio access network (RAN), a configuration for a first cell associated with an irregular synchronization signal block (SSB) transmission pattern;
receive an indication for activation of SSB transmissions for the first cell; and
perform one or more measurements based on an SSB transmission associated with the first cell and in accordance with the configuration.

10. The UE of claim 9, wherein the first cell corresponds to a deactivated secondary cell, and wherein the at least one processor is configured to cause the UE to:
determine a duration of active SSB transmission based at least in part on the configuration; and
perform the one or more measurements in response to the indication for activation and during the duration of active SSB transmission.

11. The UE of claim 9, wherein the configuration comprises a radio resource control (RRC) message, and wherein the indication for activation comprises a medium access control (MAC) control element (MAC-CE).

12. The UE of claim 9, wherein the indication for activation comprises a radio resource control (RRC) message.

13. The UE of claim 9, wherein the first cell corresponds to an on-demand cell and the irregular SSB transmission pattern corresponds to a semi-persistent SSB transmission pattern.

14. The UE of claim 9, wherein the at least one processor is configured to cause the UE to:
receive a second indication for deactivation of the SSB transmission; and
cease performing the one or more measurements of the SSB transmission in response to the second indication.

15. The UE of claim 9, wherein the configuration comprises information of a set of cells comprising the first cell, and wherein the at least one processor is configured to cause the UE to:
transmit a measurement report for a second cell from the set of cells; and
receive the indication for activation of the SSB transmission in response to a reception of the measurement report.

16. The UE of claim 15, wherein the first cell corresponds to a secondary cell, wherein the second cell corresponds to a primary cell, and wherein the second measurement report indicates a degraded radio link quality on the primary cell.

17. A processor for wireless communication, comprising:
at least one controller coupled with at least one memory and configured to cause the processor to:
receive, from a serving radio access network (RAN), a configuration for a first cell associated with an irregular synchronization signal block (SSB) transmission pattern;
receive an indication for activation of SSB transmissions for the first cell; and
perform one or more measurements based on an SSB transmission associated with the first cell and in accordance with the configuration.

18. The processor of claim 17, wherein the configuration comprises a radio resource control (RRC) message, and wherein the indication for activation comprises a medium access control (MAC) control element (MAC-CE).

19. The processor of claim 17, wherein the first cell corresponds to an on-demand cell and the irregular SSB transmission pattern corresponds to a semi-persistent SSB transmission pattern.

20. The processor of claim 17, wherein the at least one controller is configured to cause the processor to:
receive a second indication for deactivation of the SSB transmission; and
cease performing the one or more measurements of the SSB transmission in response to the second indication.
